(19) United States
(12) Patent Application Publication
(10) Pub. No.: US 2011/0002376 A1
(43) Pub. Date: Jan. 6, 2011

(54) Latency Minimization Via Pipelining of Processing Blocks

(75) Inventors: S. Nadeem Ahmed, Allen, TX (US); Matthew B. Shoemake, Allen, TX (US); Craig D. Smith, Allen, TX (US)

Correspondence Address: SWANSON & BRATSCHUN, L.L.C., 8210 SOUTHPARK TERRACE, LITTLETON, CO, 80120, US

(73) Assignee: WHAM! INC., Allen, TX (US)

(21) Appl. No.: 12/828,671

(22) Filed: Jul. 1, 2010

Related U.S. Application Data
(60) Provisional application No. 61/222,329, filed on Jul. 1, 2009.

(51) Int. Cl. H04N 7/26

(52) U.S. Cl. 375/240.01; 375/E07.026

(57) ABSTRACT

Novel tools and techniques for minimizing the latency of video processing blocks via pipelining. Video calling is a latency sensitive application. When the latency between capture at the video source and display at the video sink is too large, the call does not appear interactive. Transmission of video over a network exacerbates the problem. It is highly desirable to minimize the capture/encode/transmit latency at the video source and the receive/decode/display latency at the video sink. Certain tools disclosed herein minimize these latencies via pipelining of processing blocks. For example, in some tools, each block begins processing before the previous block has finished its processing.

### CROSS-REFERENCES TO RELATED APPLICATIONS

The present disclosure may be related to the following commonly assigned applications/patents:

This application claims the benefit, under 35 U.S.C. §119(e), of co-pending provisional U.S. Patent Application No. 61/222,329 filed Jul. 1, 2009, by Ahmed et al. and titled “Latency Minimization via Pipelining of Processing Blocks,” which is hereby incorporated by reference, as if set forth in full in this document, for all purposes.

This application may also be related to of co-pending U.S. patent application Ser. No. 12/561,165 (the “'165 Application”), filed Sep. 16, 2009, by Shoemake et al. and titled “Real Time Video Communications System” (published Mar. 18, 2010 as US. Pat. App. Pub. No. US-2010-0066804-A1), which is hereby incorporated by reference, as if set forth in full in this document, for all purposes, and which claims priority from provisional U.S. Patent Application No. 61/097,379 (the “'379 Application”), entitled “Real Time Video Communications System” and filed Sep. 16, 2008 by Shoemake et al., which is hereby incorporated by reference, as if set forth in full in this document, for all purposes.

The respective disclosures of these applications/patents are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to video transmission, and more particularly, to techniques for efficiently transmitting video and other data.

### BACKGROUND

Video calling is a latency-sensitive application. (As used herein, the term “latency” means a delay between the time video is captured and the time that video is displayed.) Latency can be disruptive in a video call, because of the two-way nature of that application. If latency is too high, a user will experience a noticeable delay after she speaks and her counterpart replies. In fact, in these situations, the adverse effects of latency are magnified because there will be latency in the transmission of the user's speech and latency in the transmission of the counterpart's reply. Accordingly, end-to-end latency between the time the video is captured by the video source and displayed by the video sink needs to be small for the call to appear interactive. The steps in the chain between capture and display can include, without limitation, capture (which might include video conditioning and/or processing), encode, network (transmit and receive), decode, and/or display. Each of these steps can be a source of latency in a video call.

The amount of time between the start of capture of a video frame and the start of display for that same frame is the latency. The latency introduced by the capture, encode, decode and display blocks needs to be minimized, as these variables are controllable by the system designer, while the network latency is largely uncontrollable. Minimizing this controllable latency allows the network delay to be as large as possible before it affects the quality of the video call.

Most hardware that exists to perform video capture/conditioning, video encode, video decode and video display typically operates on a frame basis. In other words, an entire frame needs to be presented to each processing block before any processing can begin. This automatically introduces a frame of delay for each block that operates in this manner. For example, if each of the capture/condition, encode, decode, and display blocks each operate in this manner, then the video calling system will have at least 4 frames of latency. Network latency will add to this amount.

Achieving low latency for video calling systems today often involves using expensive custom hardware and software solutions. These custom solutions can be engineered in a manner that allows for low-latency, since each block can be tuned by the designer. However, such systems are cost-prohibitive for consumer applications. This can be seen in the corporate video conferencing market, where solutions achieve low latency, but can often cost in excess of $100,000 per system. Clearly, this approach will not work for high volume consumer applications that cost a minute fraction of this amount.

For applications such as low-cost consumer video calling systems, designing or using custom hardware that operates on a sub-frame basis is cost prohibitive. Therefore, using lower-cost, pipelined processing in a manner that can still achieve low-latency is highly desirable.

### BRIEF SUMMARY

A set of embodiments provides tools and techniques for minimizing the latency in encoding and/or decoding video streams. In an aspect, certain embodiments pipeline various processes involved in the video capture, encoding, transmission, reception, decoding, and/or display of video. While traditional techniques typically do not operate on a subframe basis, thereby introducing latency into the system as various operations must wait for a prior operation to complete before commencing, certain embodiments allow such operations to be commenced before the prior operation has been completed. This pipelining can reduce the latency exhibited by more traditional systems, providing an enhanced user experience.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

Merely by way of example, a method in accordance with one set of embodiments can be implemented to minimize latency in video streaming. The method, in one embodiment, comprises capturing, at a first computer system, a segment of video from a video source. The method might further comprise encoding the segment of video at first the computer system. In certain embodiments, encoding the segment of video comprises encoding a portion of the segment before the entire segment has been captured. In some aspects, the method additionally comprises transmitting the encoded segment from the first computer system for reception by a second computer system. In some embodiments, a portion of the segment might be transmitted before the entire segment has been encoded.

Another method, in accordance with a second set of embodiments, comprises receiving an encoded segment of video at a computer system, and/or decoding the encoded segment at the computer system, wherein decoding the encoded segment comprises decoding at least a portion of the encoded segment before the entire encoded segment has been received. In some embodiments, the method further comprises displaying the decoded segment on a display device in communication with the computer system, perhaps before the entire segment has been decoded.

As noted above, other embodiments provide systems. An exemplary system might comprise one or more processors, a video capture processing block that captures a segment of video from a video source, an encoding processing block that encodes the segment of video at first the computer system, and/or a transmitting processing block that transmits the encoded segment from the first computer system for reception by a second computer system. In an aspect, the video encoding block might encode a portion of the segment before the entire segment has been captured. In an aspect, the transmitting processing block might transmit a portion of the segment before the entire segment has been encoded.

Another exemplary system might comprise one or more processors, a receiving processing block that receives an encoded segment of video at a computer system, a decoding processing block that decodes the encoded segment at the computer system, and/or a displaying processing block that displays the decoded segment on a display device in communication with the computer system. In an aspect, the decoding processing block decodes a portion of the encoded segment before the entire encoded segment has been received. In an aspect, the display processing block might display a portion of the segment before the entire segment has been decoded.

Another set of embodiments might provide software and/or firmware instructions that are encoded on a computer readable medium. Such instructions can implement the processing blocks described herein and/or can cause a computer system or other device to perform operations in accordance with the methods described herein.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIGS. 1-4 are timing diagrams illustrating methods of transmitting video, in accordance with various embodiments.

FIG. 5 is a process flow diagram illustrating a method of transmitting data, in accordance with one set of embodiments.

FIG. 6 is a process flow diagram illustrating a method of receiving data, in accordance with one set of embodiments.

FIG. 7 is a generalized architectural diagram illustrating a system for conducting a video call, in accordance with one set of embodiments.

FIG. 8 is a generalized schematic diagram illustrating a computer system, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for purposes of explanation, numerous specific details are set forth in order to provide a thorough understanding of the described embodiments. It will be apparent to one skilled in the art, however, that other embodiments of the present may be practiced without some of these specific details. In other instances, certain structures and devices may be shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Certain embodiments can minimize the latency in encoding and/or decoding video streams. In an aspect, some embodiments pipeline various processes involved in the video capture, encoding, transmission, reception, decoding, and/or display of video. While traditional techniques typically operate on a frame-by-frame basis, thereby introducing latency into the system as various operations must wait for a prior operation to complete before commencing with respect to a particular video frame, features of various embodiments allow such operations to be commenced before the prior operation has been completed. This pipelining can reduce the latency exhibited by more traditional systems, providing an enhanced user experience.

Various embodiments, therefore, can enable a low-latency video calling system to be constructed without the need for custom hardware. In an aspect of certain embodiments, standard video capture and display hardware can be used with standard video codecs, without the need for expensive, customized hardware or software.

For example, some embodiments can support high definition video capture and transmission (e.g., 720 p at 30 frames per second, 24 frames per second, or 20 frames per second), depending on network latency and throughput. Using the techniques described herein, one-way glass-to-glass latency of 150 ms can be accomplished. (As used herein, the term “glass-to-glass” refers to the entire video flow—in one direction—from imaging at the camera to display at the remote display device). Research has shown that many people become uncomfortable with a round-trip latency of over approximately 300 ms when conversing (by phone, video conference, etc.). With round-trip latency over approximately 300 ms, many people find conversations to be disjointed, which degrades the feeling of interactivity between participants to the conversation, and by extension, the user experience. Accordingly, a one-way glass-to-glass latency of approximately 150 ms is generally considered an upper bound for providing an adequate consumer experience in many applications. This level of latency can be achieved in some embodiments described herein, for example, using an H.264 baseline profile (without B frames) and/or the pipelining techniques described herein.

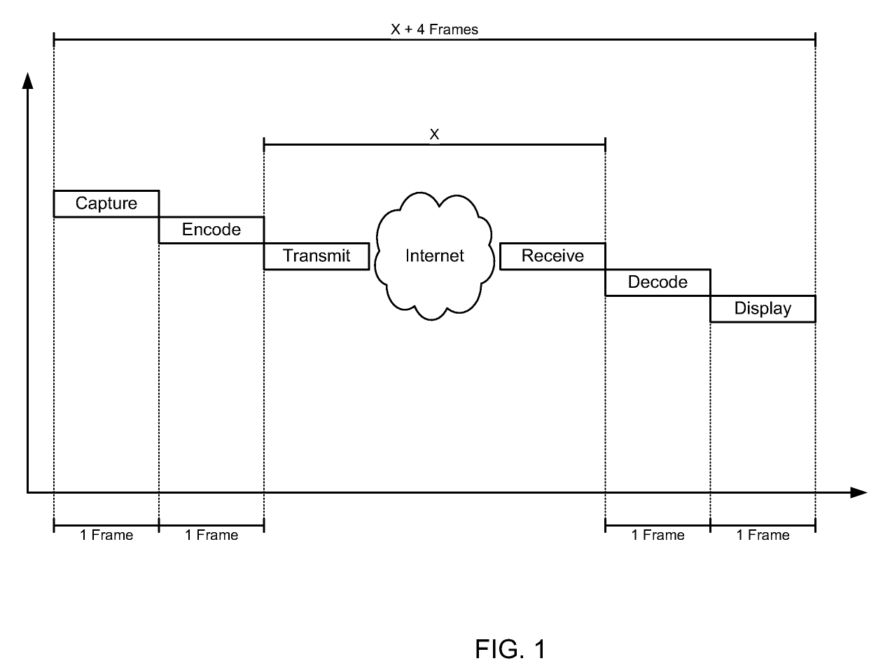

We first describe the performance of a baseline system. In such a system, each processing block is frame-based and begins frame processing once the previous block has finished processing. FIG. 1 illustrates the latency that can be expected with this baseline system. (In the examples that follow, the term “frame” is used for illustrative purposes to describe any segment of a video stream that can be captured, processed, and/or displayed by the various described embodiments. While those skilled in the art will appreciate that a conventional “frame” of video typically represents a single image in a series of images of which a video stream is comprised, the term “frame” is used more generally in the examples below to refer to any segment of a video stream. Such a segment might comprise a single conventional frame, multiple conventional frames, or one or more slices of a single conventional frame. It should be appreciated, therefore, that various embodiments are not limited to pipelining video processing one conventional frame at a time.) Various embodiments provide for pipelining systems with codecs (e.g., H.264 codecs) that allow multiple slices per frame as well as codecs that only allow a single slice per frame.

One skilled in the art will appreciate that signal processing applications often employ a callback procedure, in which a processing block notifies the system when it has finished processing a discrete set of data (such as a frame of video). In some cases, multiple slice/frame support with a callback per slice is one mechanism that can help reduce latency. Moreover, since performance sometimes suffers due to the callback, it may be possible to have multiple slices/frame without employing a callback using the pipelining techniques described herein. Merely by way of example, if the system has knowledge of the write pointer location, the system may be able to pipeline operations without the callback.

FIG. 1 follows the latency for a single video frame. We can see that there is 1 frame of latency that is introduced during the capture process. Once the frame is captured into system memory, it can be encoded which introduces another frame of latency. The encoded frame is then transmitted over the Internet, which adds a random amount of latency denoted by X. On the receive side, the decode process adds another frame of latency, as does the display process. The entire process introduces X+4 frames of latency (including network latency). This system works well for many applications that are not latency-sensitive, such as media playback from a disk. However, it often is not ideal for real-time interactive video systems. If, for example, each frame is approximately 33 ms long (which would correspond to a capture rate of approximately 30 frames per second), the one-way, glass-to-glass latency will exceed 150 ms (which, as noted above, can degrade the user experience in many applications) if the network latency is over 18 ms. Given that network latencies for the Internet often range between 50-100 ms, this baseline technique will often produce a one-way, glass-to-glass latency of between 180-250 ms, which often will not provide an adequate user experience.

Using the same frame-based processing blocks in the baseline system, the latency can be reduced significantly by pipelining the video processing blocks. This allows use of lower cost hardware with the latency advantages of far more costly custom solutions. Many embodiments of the invention are possible using different pipelining configurations and different triggers that determine when to begin each pipelined stage. Several of these are discussed below. Once again, it should be noted that, although the examples below contemplate frame-by-frame processing, various embodiments can apply the same principles to video segments of any appropriate length.

Pipelining Capture/Encode and/or Decode/Display

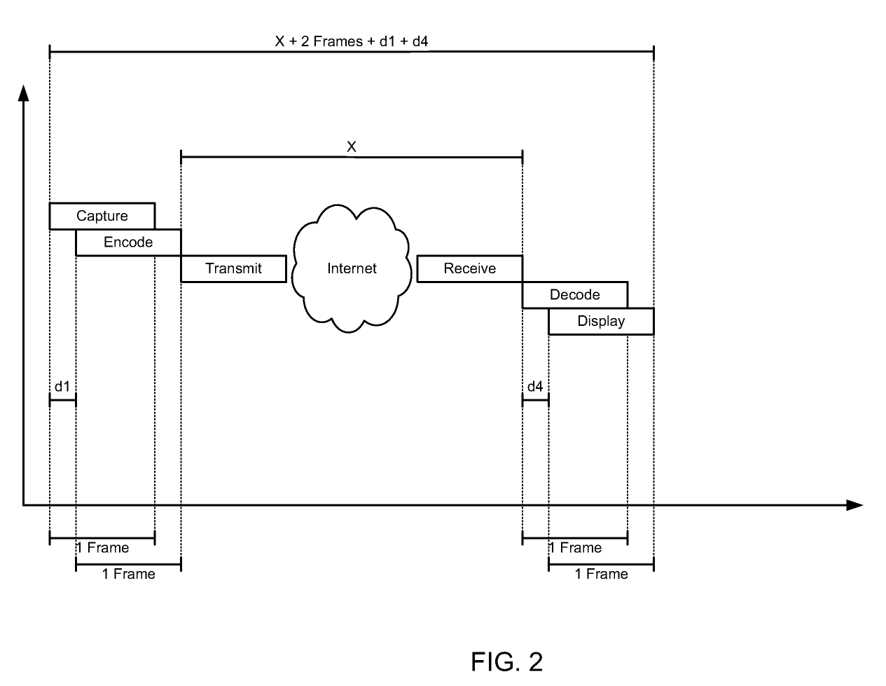

FIG. 2 depicts the operation of one embodiment. In accordance with this embodiment, the capture/encode and decode/display blocks are pipelined. The video encode process for a frame is started before the video capture is complete, and the video display process is started before the video decode is complete. In this figure, d1 corresponds to the pipelining delay between encode and capture and d4 corresponds to the pipelining delay between decode and display.

For example, an embodiment might pipeline the capture/encode stage by starting the encode process d1 ms after the capture process has started. According to this embodiment, with multiple slices per frame, the encoder can be started once enough data for a slice has been captured (since each slice can be encoded independently). With a single slice per frame, the encoder can be started once enough data has been captured to successfully allow motion estimation. In an aspect, the value selected for d1 might depend on the architecture, i.e., either multi-slice/frame or single slice/frame.

Similarly, an embodiment might pipeline the decode/display stage by starting the display process d4 ms after the decode process has started. In an aspect, d4 can be selected to be as small as possible to prevent a display underrun. Once again, the value selected for d4 might depend on the architecture, i.e., either multi-slice/frame or single slice/frame.

In the embodiment illustrated by FIG. 2, the overall system latency is X+2 frames+d1+d4, where X is represents the network latency. Thus, with an exemplary frame duration of 33 ms, the technique illustrated by FIG. 2 can absorb X=(84−d1−d4) ms of network latency before crossing the 150 ms glass-to-glass latency threshold. This technique will work well for some applications, if d1 and d4 are sufficiently small, given a network latency of 50-100 ms, as described above, but will not work well for other applications or when network latency is at the high end of the estimated range.

Pipelining Encode/Transmit and/or Receive/Decode

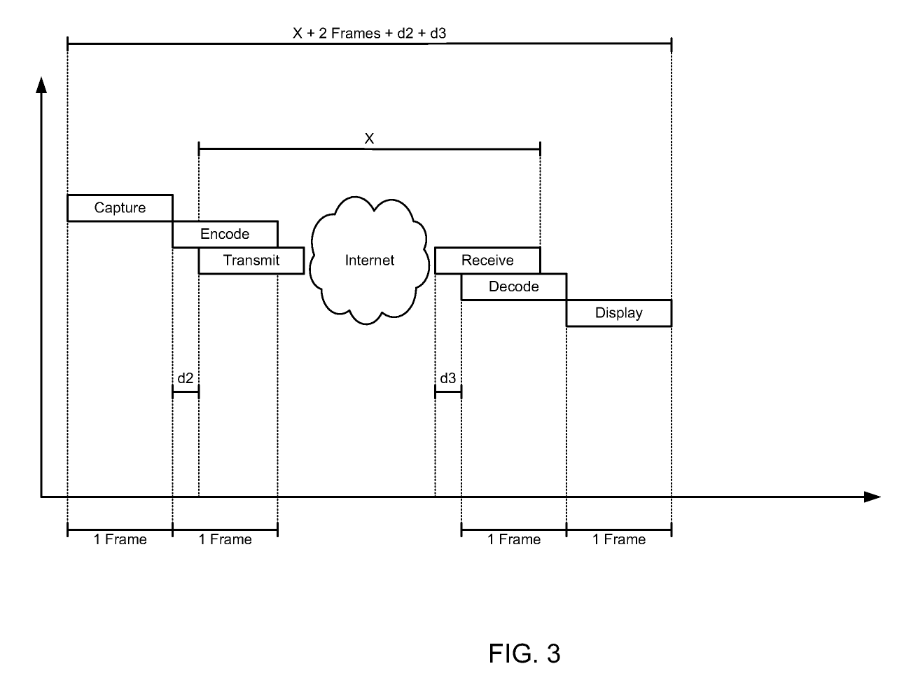

FIG. 3 depicts the operation of another embodiment. Here the encode/transmit and receive/decode block are pipelined. The transmit process for a frame is started before the encode process for the frame is complete. Similarly, the decode process for a frame is started before the receive process is complete. In this figure, d2 corresponds to the pipelining delay between the transmit and encode blocks, while d3 corresponds to the pipelining delay between the receive and decode blocks.

For example, in one embodiment, the system will pipeline the encode/transmit stage by starting the transmit process d2 ms after the capture process has started. With multiple slices per frame, transmission can start once the encoding of the first slice is complete. Particular embodiments can transmit as little as 1 slice (NAL Unit) per packet when network conditions warrant, according to IETF RFC 3984. With a single slice per frame, the transmit can occur once the encoder outputs enough data for a packet (assuming that motion estimation and entropy coding are pipelined internally in the encoder).

Another embodiment will pipeline the receive/decode stage by starting the decode process d3 ms after the receive process has started. In some cases, a small buffer (much less than 1 frame, in certain embodiments) may be used to smooth out network jitter and to reorder and/or discard data before it is presented to the decoder. With multiple slices/frame, decode can begin once enough data for 1 slice is present (since each slice can be decoded independently), while with a single slice/frame, decode can begin once enough data for motion compensation and entropy decode is available (assuming the motion compensation and entropy decode are pipelined internally in the decoder). Once again, the values of d2 and d3 might depend on the architecture (single slice per frame or multiple slices per frame).

The overall system latency in this example is X+2 frames+d2+d3, where X represents the network latency. Thus, with an exemplary frame duration of 33 ms, the technique illustrated by FIG. 2 can absorb X=(84−d2−d3) ms of network latency before crossing the 150 ms glass-to-glass latency threshold. This technique will work well for some applications, if d2 and d3 are sufficiently small, given a network latency of 50-100 ms, as described above, but will not work well for other applications or when network latency is at the high end of the estimated range.

Pipelining Capture/Encode/Transmit/Receive/Decode/Display

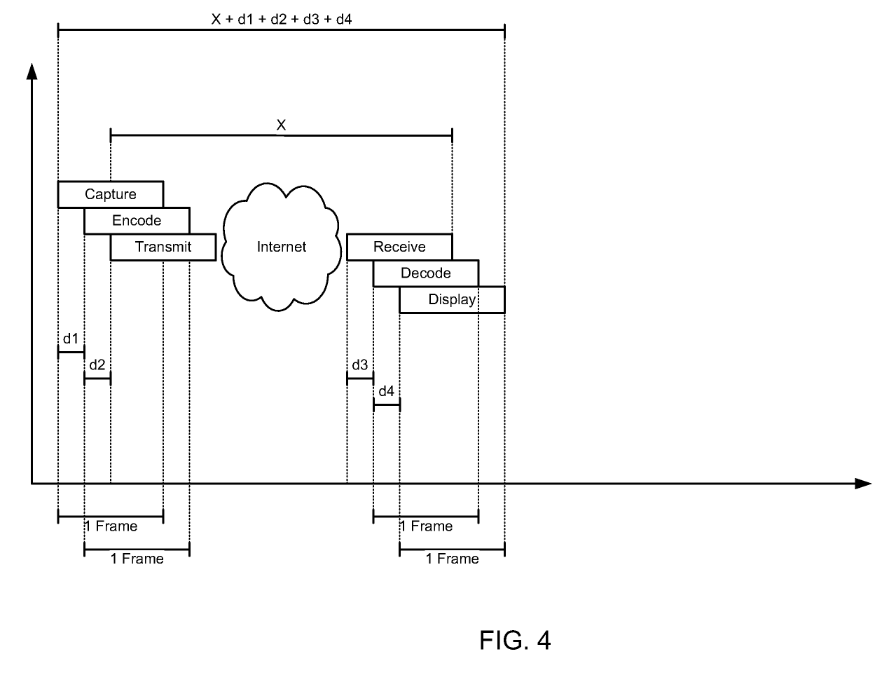

FIG. 4 depicts the operation of yet another embodiment. In the embodiment illustrated by FIG. 4, a fully pipelined architecture is shown, in which capture/encode/transmit are pipelined, and receive/decode/display are pipelined as well. Here, d1 corresponds to the pipelining delay between capture and encode, d2 corresponds to the pipelining delay between encode and transmit, d3 the pipelining delay between receive and decode, and d4 the pipelining delay between decode and display. The overall system latency in this embodiment is X+d1+d2+d3+d4, where X represents the network latency. This system will work well for many applications, if d1, d2, d3, and d4 are sufficiently small, since such values would allow for network latency X to exceed 100 ms and still provide glass-to-glass latency of less than 150 ms. (It should be noted, of course, that each stage can be pipelined independently of the others, and that one should not infer, from the examples above, that any particular combinations of pipelined stages are required by any particular embodiment.

Pipelining Delay Triggers

Pipelining provides benefits in reducing overall system latency, because the pipelining delays d[i] can be made smaller than the delay of a single frame. Another key aspect of certain embodiments lies in their ability to determine values for d[i]. Knowledge of this timing is important for proper pipelining operation, since each block must not “run ahead” of the preceding block. In some embodiments, each pipelining delay d[i] might have a different value (and/or some steps might not be pipelined at all). In other embodiments, all of the pipelining delays d[i] might have similar values, or at least magnitudes. As a general matter, the pipelining delay at each processing block will be selected to minimize overall delay while still ensuring that the block has sufficient data to begin operating. In many (but not all) cases, a delay of between 5-25% of the frame length will provide satisfactory results. For example, in an embodiment that encodes video at 30 frames per second, each pipelining delay d[i] might last between 1.5 ms and 7 ms, and more particularly, between 2.5 ms and 3.5 ms.

With respect to each pipelining delay d[i], it is important to note that, depending on the embodiment, the delay d[i] can be selected and/or calculated at run-time (based, for example, on monitoring the status of a buffer on which the respective processing block operates) and/or selected/calculated a priori (using, for example, values that will provide satisfactory results in a typical case). In fact, in some cases, one or more of the delay values might be selected and hard-coded (into software, firmware, etc.) during production. In other cases, one or more delay values might be selected/calculated prior to beginning the capture operation, (e.g., based on available throughput, video encoding presets, etc.), while in still other cases, the values may be calculated/selected at run-time (e.g., immediately prior to performance of the pipelined operation). Thus, when this document refers to selecting a particular delay value, it should be understood that such a selection can include, but need not necessarily include, a calculation that is performed at run time.

Pipelining Delay d1

In one embodiment, the pipelining delay d1 can be determined based on timing information from the source video signal itself, such as a frame start signal. An example of such a signal is the vertical synchronization (or “vsync”) signal, although others exist as well. These signals can be used to determine the start of a video frame, and the delay d1 can be selected to ensure that an underflow does not happen to the encode process. In another embodiment, the amount of data in the capture buffer can be used as a trigger to start the encode process. In this embodiment, the value of the delay d1 might be selected to correspond to the amount of time it takes the capture buffer to reach a certain threshold. In another embodiment, if the encoder process operates on video “slices,” then the value of the delay d1 might be selected to correspond to the amount of time it takes to capture 1 slice worth of data. In another embodiment, d1 corresponds to the amount of time it takes to fill the capture buffer so that the first part of the encoder, the motion estimation function, does not underrun.

Pipelining Delay d2

In one embodiment, value of the pipelining delay d2 can be based on the amount of time it takes to encode and fill a buffer of a predetermined size. This size, in an aspect, might correspond to the size of packet that will be transmitted across the network. In another embodiment, the value of the delay d2 corresponds to the amount of time it takes to encode a predetermined number of “macroblocks,” e.g., if the video encoder is based on macroblock units. In another embodiment, the delay d2 is determined by the amount of time it takes to encode a predetermined number of “slices” if the video encoder is based on slices.

Pipelining Delay d3

In one embodiment, the value of the pipelining delay d3 can be based on a fixed amount of time after the first packet of a video frame is received. This amount of time might be selected to ensure that the decode process does not underflow. In another embodiment, the value of d3 might correspond to the amount of time it takes to fill a receive buffer to a predetermined depth. This buffer can be used to ensure that the decoder does not underrun, and/or to absorb latency jitter that is introduced by the network. This buffer can also be used to reorder packets that arrive out order from the network and to discard packets that arrive too late to be decoded.

Pipelining Delay d4

In one embodiment, the pipelining delay d4 might be selected based on a fixed amount of time after the decode process has started. In another embodiment, the display process can be started after the decode buffer has reached a predetermined level. Both of these methods can be used to ensure that an underrun does not occur for the display process.

Exemplary Implementations

Various embodiments can be implemented using a wide variety of hardware, software, and/or network configurations. Merely by way of example, in one embodiment, the video pipelining techniques described above can be implemented in a system such as the systems described in the '379 Application and the '165 Application.

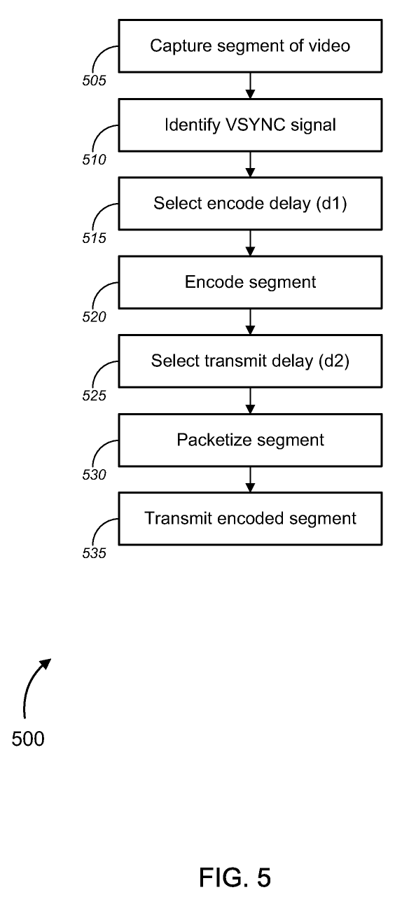

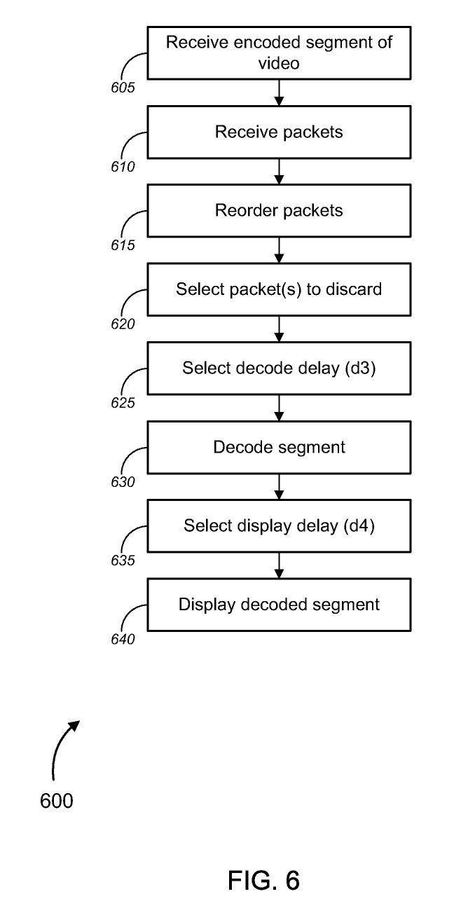

To illustrate one exemplary implementation, FIG. 5 illustrates a method 500 of transmitting data (e.g., video data), in accordance with one set of embodiments, and FIG. 6 illustrates a method 600 of receiving data (e.g., video data), in accordance with another set of embodiments. It should be appreciated that the methods 500 and 600 can be used together; for example, the method 500 can be performed by a transmitting device, and the method 600 can be performed by a receiving device (each of which might, for example, be the types of devices described in the '379 Application and the '165 Application). Further, a single device might perform both the transmitting method 500 and the receiving method 600; for example, a first device might perform the transmitting method 500 to transmit data for reception by a second device and might perform the receiving method 600 to receive data transmitted by the second device. With both devices performing both methods, the devices can be used to perform an interactive video call, in the fashion described in the '379 Application and the '165 Application, for example.

The method 500 of FIG. 5 comprises capturing a segment of video (block 505). A segment of video might comprise a conventional frame of video, a set of two or more conventional frames, or a portion of a conventional frame. Typically, capturing a segment of video will comprise receiving video data from a video source, such as a camera or other video capture device. In a particular embodiment, for example, the video is captured by a camera and provided to the processing system in the format specified by ITU-R BT.1120-7. Additionally, the capture process often will include conditioning of the captured signal, which might be performed prior to encoding. Such conditioning can include, merely by way of example, image processing such as white balancing, color adjustment, automatic exposure adjustment, and/or the like.

In some embodiments, the method 500 will include identifying a frame start signal (block 510), and/or selecting an encode delay (described herein using the reference d1), as described above (block 515), e.g., based at least in part on the frame start signal, on the time required to fill a buffer, etc. As noted above, one type of frame start signal is a vsync signal, although embodiments can make use of any available type of video sequence signaling, including without limitation other types of frame start signals.

In an embodiment, the method 500 further comprises encoding the video segment (block 520). In a particular embodiment, encoding the segment of video comprises encoding a portion of the segment before the entire segment has been captured, as described above. A variety of encoding techniques and/or hardware can be implemented in accordance with different embodiments. Merely by way of example, certain embodiments employ a DM365 digital signal processing chip available from Texas Instruments Inc. Such processors are capable of encoding video using a variety of codecs, including H.264, MPEG-4, MPEG-2, and the like, although any appropriate codec may be used to encode the video. In some aspects, the codec selected might be able to recover from packet loss (e.g., by detecting and/or localizing semantic/syntax errors) and/or to conceal errors upon decoding. In some cases, a single device might include two processors (e.g., DSPs), e.g., one to perform encoding operations, and the other to perform decoding operations; these processors may be identical or may be of different types. Either or both of the processors may be configured to also handle the receive/transmit operations.

At block 525, the method 500 comprises selecting a transmit delay value (referred to herein as d2), for example using the techniques described above. After the transmit delay, the method 500 can include transmitting the encoded video segment. In a particular embodiment, the transmit procedures comprise packetizing the encoded segment to produce a plurality of data packets (e.g., IP datagrams that can be transmitted over an IP network, such as the Internet) (block 230). The encoded (and, depending on the embodiment, packetized) video segment is then transmitted (block 235), e.g., using conventional data transmission techniques. In an aspect of certain embodiments, an encoded portion of the video segment (e.g., some of the data packets produced by the packetizing procedures) is transmitted before the entire segment has been encoded, as described above.

In some aspects, the method 600 of receiving the data can be considered to be essentially the converse of the transmission method 500. At block 605, the method comprises receiving the encoded video segment (e.g., via an IP network over which the video was transmitted). In an aspect, receiving the video segment might comprise receiving a plurality of data packets (block 610), reordering the packets as necessary (block 615) and/or selecting one or more packets to discard (block 620), for example, if one or more of the packets were corrupted during transmission, received out of order, and/or the like.

The method 600 might further comprise selecting a decode delay (referred to herein as d3), for example using the techniques described above (block 625), and/or decoding the video segment (block 630), e.g., using the same codec (and perhaps similar hardware) with which the video was encoded. In an aspect, the method 600 can provide for decoding a portion of the video segment before the entire segment has been received.

In other embodiments, any type of computer system with appropriate hardware and/or software may be used to implement the tools and techniques described above. In some embodiments, for example, a computer system might be implemented as a set-top box. The computer system might use a video capture device, such as a video camera, as a video source. This video source might be in communication with the computer system, using any appropriate communication technique (e.g., USB, wireless USB, Wi-Fi, WiMax, etc.). The computer system might also be in communication (again, using any appropriate communication technique) with a display device, such as a high-definition television (“HDTV”), computer monitor, etc. In a particular embodiment, the computer system might incorporate the video capture device and/or the display device. In some cases, the method 600 comprises selecting a display delay value (referred to herein as d4), for example using the techniques described above (block 635) and/or displaying the decoded segment (e.g., providing a decoded video stream on an interface for display on a video sink, such as a display device, television, etc., and/or actually showing the video on such a device) (block 640).

While the techniques of FIGS. 1-4 and the methods of FIGS. 5 and 6 are illustrated discretely for ease of description, it should be appreciated that the various techniques and procedures illustrated by these figures can be combined in any suitable fashion, and that, in some embodiments, the methods depicted by FIGS. 5 and 6 can be considered interoperable and/or as portions of a single method, which may incorporate one or more of the techniques described with respect to FIGS. 1-4. Similarly, while the techniques and procedures are depicted and/or described in a certain order for purposes of illustration, it should be appreciated that certain procedures may be reordered and/or omitted within the scope of various embodiments (merely by way of example, the selection of delay values need not necessarily immediately precede the pipelined operation).

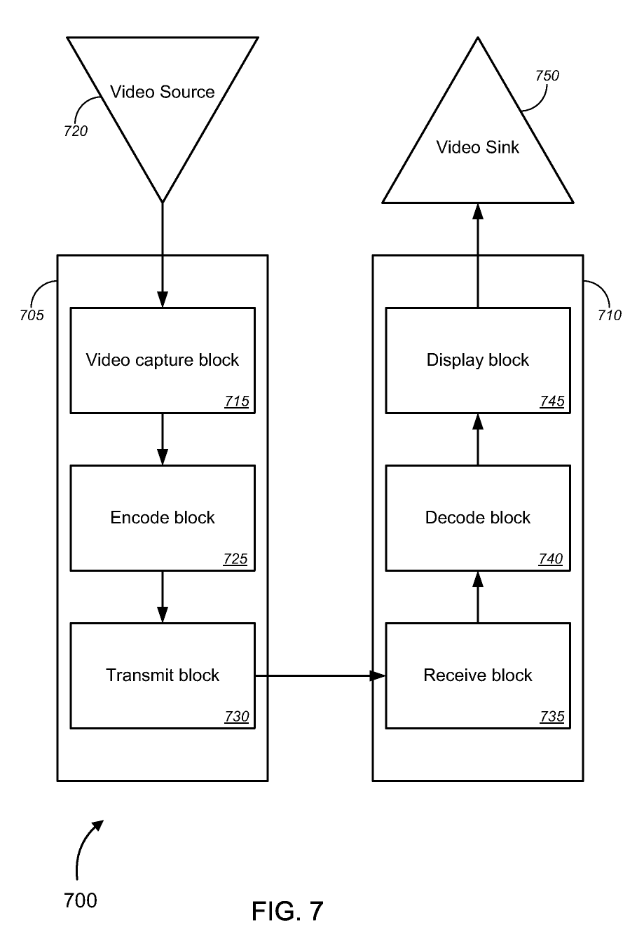

Moreover, while the methods and techniques illustrated by FIGS. 1-6 can be implemented by (and, in some cases, are described below with respect to) the systems 700 and 800 of FIG. 7 (or components thereof), these methods may also be implemented using any suitable hardware implementation. Similarly, while the systems 700 and 800 (and/or components thereof) can operate according to the methods and techniques illustrated by FIGS. 1-6 (e.g., by executing instructions embodied on a computer readable medium), the systems 700 and 800 can also operate according to other modes of operation and/or perform other suitable procedures.

Thus, FIG. 7 illustrates a hardware architecture 700 in accordance with certain embodiments. This architecture 700, which is illustrated functionally, can be used, inter alia, to perform the methods 500 and/or 600 described above, and/or to perform the techniques illustrated by FIGS. 1-4 above. The functional architecture can be implemented as sets of computer-executable instructions or code (e.g., applications, processing blocks, etc.) encoded in RAM, ROM, etc., to be executed on a processor within a computer system or other device, such as the computer system 800 described below and/or the devices described in the '379 Application and the '165 Application.

According to FIG. 7, the architecture 700 comprises a first device 705 and a second device 710 (each of which, as noted above, may be a computer system, such as the system 800 described below and/or devices such as those described in the '379 Application and the '165 Application). As illustrated, one of the devices 705 captures, encodes, and transmits video, while the other device 710 receives, decodes, and displays the video. It should be appreciated, of course, that the roles of the devices can be reversed, such that the device 710 captures, encodes, and transmits the video, while the other device 705 receives, decodes, and displays the video. In fact, both the transmit and receive procedures can be performed simultaneously and correspondingly on both devices, allowing for an interactive video call.

As illustrated, the transmitting device 705 includes a video capture processing block 715, which receives video from a video source 720 (such as a camera or other video capture device) and performs the video capture functions described above. The captured video is provided to an encoding processing block 725, which (perhaps after a delay d1) encodes the video as described above and passes the encoded video to a transmission processing block 730, which transmits the video (perhaps after a delay d2) as described above.

At the receiving device 710, the transmitted video is received at a receiving processing block 735, which performs receiving functions as described above, and provides the received video to a decoding processing block 740, which decodes the video using the appropriate codec, in the manner described above (perhaps after a delay d3). The decoding processing block 740 provides the decoded video to a display processing block, which displays the video as described above (perhaps after a delay d4). For example, the display processing block might output the video (e.g., in BT-1120 format) for display on a video sink 750, such as a display device, television, etc.

Thus in certain embodiments, a first computer system (or other device) 705 might maintain communication with a second computer system (or other device) 710. It is anticipated that the respective computer systems might be located remote from one another and/or might communicate over any appropriate communication network, such as the Internet. In some cases, the communications between the computers might be intermediated by one or more server computers, which receive data from the transmitting computer and/or relay the data to the receiving computer. (Optionally, the server computer(s) might perform additional operations, such as processing and/or storing the transmitted data for later use.)

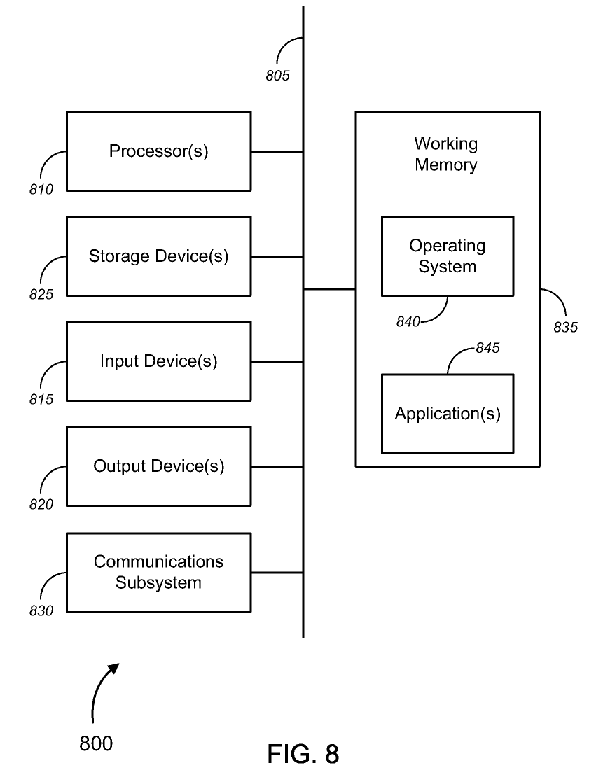

FIG. 8 provides a schematic illustration of one embodiment of a computer system 800 that can perform the methods and techniques provided by various other embodiments, as described herein, and/or can function as a video communication device. It should be noted that FIG. 8 is meant only to provide a generalized illustration of various components, of which one or more (or none) of each may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips including without limitation the DM365 processor described above, graphics acceleration processors, and/or the like); one or more input devices 815 (or interfaces therefore), which can include without limitation a video source such as a camera, a touch screen, a mouse, a keyboard and/or the like; and one or more output devices 820 (or interfaces therefore), which can include without limitation a video sink such as a display device, a printer and/or the like.

The computer system 800 may further include (and/or be in communication with) one or more storage devices 825, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updatable and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infra-red communication device, a wireless communication device and/or chipset (such as a Bluetooth™ device, an 802.11 device, a Wi-Fi device, a WiMax device, a WWAN device, cellular communication facilities, etc.), and/or the like. The communications subsystem 830 may permit data to be exchanged with a network (such as the network described below, to name one example), with other computer systems, and/or with any other devices described herein. In many embodiments, the computer system 800 will further comprise a working memory 835, which can include a RAM or ROM device, as described above.

The computer system 800 also may comprise software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the techniques and method discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 825 described above. In some cases, the storage medium might be incorporated within a computer system, such as the system 800. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 800) to perform methods in accordance with various embodiments of the invention. According to a set of embodiments, some or all of the procedures of such methods are performed by the computer system 800 in response to one or more processors 810 executing one or more sequences of one or more instructions (which might be incorporated into the operating system 840 and/or other code, such as an application program 845, processing block, etc.) contained in the working memory 835. Such instructions may be read into the working memory 835 from another computer readable medium, such as one or more of the storage device(s) 825. Merely by way of example, execution of the sequences of instructions contained in the working memory 835 might cause the processor(s) 810 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 800, various computer readable media might be involved in providing instructions/code to processor(s) 810 for execution and/or might be used to store and/or carry such instructions/code (e.g., as signals). In many implementations, a computer readable medium is a non-transitory, physical and/or tangible storage medium. Such a medium may take many forms, including but not limited to non-volatile media, volatile media, and transmission media. Non-volatile media includes, for example, optical and/or magnetic disks, such as the storage device(s) 825. Volatile media includes, without limitation, dynamic memory, such as the working memory 835. Transmission media includes, without limitation, coaxial cables, copper wire and fiber optics, including the wires that comprise the bus 805, as well as the various components of the communication subsystem 830 (and/or the media by which the communications subsystem 830 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various embodiments.

The communications subsystem 830 (and/or components thereof) generally will receive the signals, and the bus 805 then might carry the signals (and/or the data, instructions, etc. carried by the signals) to the working memory 835, from which the processor(s) 805 retrieves and executes the instructions. The instructions received by the working memory 835 may optionally be stored on a storage device 825 either before or after execution by the processor(s) 810.

While certain features and aspects have been described with respect to exemplary embodiments, one skilled in the art will recognize, based on the disclosure herein, that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of minimizing latency in video streaming, the method comprising:
capturing, at a first computer system, a segment of video from a video source;
encoding the segment of video at first the computer system, wherein encoding the segment of video comprises encoding a portion of the segment before the entire segment has been captured; and
transmitting the encoded segment from the first computer system for reception by a second computer system.

2. The method of claim 1, wherein the segment of video comprises a frame of video.

3. The method of claim 1, wherein the segment of video comprises a plurality of frames of video.

4. The method of claim 1, wherein the segment of video comprises a slice of a frame of video.

5. The method of claim 1, wherein capturing a segment of video comprises conditioning the segment of video.

6. The method of claim 1, further comprising selecting a delay value “d1” that represents an amount of time between when the capture of the segment begins and when the encoding of the segment begins.

7. The method of claim 6, further comprising identifying a frame start signal in the segment, wherein d1 is selected based on the frame start signal.

8. The method of claim 7, wherein the frame start signal comprises a vertical synchronization (“vsync”) signal.

9. The method of claim 7, wherein transmitting the encoded segment comprises transmitting a portion of the encoded segment before the entire segment has been encoded.

10. The method of claim 9, further comprising selecting a delay value “d2” that represents an amount of time between when the encoding of the segment begins and when the transmission of the segment begins.

11. The method of claim 9, wherein transmitting the encoded segment comprises:
packetizing the encoded segment to produce a plurality of data packets; and
transmitting one or more of the data packets before the entire segment has been packetized.

12. The method of claim 1, further comprising:
receiving the encoded segment at the second computer system;
decoding the encoded segment at the second computer system, wherein decoding the encoded segment comprises decoding a portion of the encoded segment before the entire encoded segment has been received; and
displaying the decoded segment on a display device in communication with the second computer system.

13. The method of claim 12, further comprising selecting a delay value “d3” that represents an amount of time between when the receiving of the encoded segment begins and when the decoding of the encoded segment begins.

14. The method of claim 12, wherein displaying the decoded segment comprises displaying a portion of the decoded segment before the entire segment has been decoded.

15. The method of claim 14, further comprising selecting a delay value “d4” that represents an amount of time between when the decoding of the encoded segment begins and when the displaying of the decoded segment begins.

16. The method of claim 12, wherein receiving the encoded segment comprises receiving a plurality of data packets representing the encoded segment.

17. The method of claim 16, further comprising:
reordering one or more of the received data packets prior to decoding the encoded video segment.

18. The method of claim 16, further comprising:
selecting one or more of the received data packets to discard prior to decoding the encoded video segment.

19. A method of minimizing latency in video streaming, the method comprising:
capturing, at a first computer system, a segment of video from a video source;
encoding the segment of video at first the computer system; and
transmitting the encoded segment from the first computer system for reception by a second computer system, wherein transmitting the segment of video comprises transmitting a portion of the segment before the entire segment has been encoded.

20. An apparatus, comprising:
a computer readable medium having encoded thereon a set of instructions executable by one or more computers to perform one or more operations, the set of instructions comprising:
instructions for capturing, at a first computer system, a segment of video from a video source;
instructions for encoding the segment of video, wherein the instructions for encoding the segment of video comprise instructions for encoding a portion of the segment before the entire segment has been captured; and
instructions for transmitting the encoded segment from the first computer system for reception by a second computer system.

21. A computer system, comprising:
one or more processors; and
a computer readable medium in communication with the one or more processors, the computer readable medium having encoded thereon a set of instructions executable by the computer system to perform one or more operations, the set on instructions comprising:
instructions for capturing a segment of video from a video source;
instructions for encoding the segment of video, wherein the instructions for encoding the segment of video comprise instructions for encoding a portion of the segment before the entire segment has been captured; and
instructions for transmitting the encoded segment for reception by a second computer system.

22. A system, comprising:
one or more processors;
a video capture processing block that captures a segment of video from a video source;
an encoding processing block that encodes the segment of video at first the computer system, wherein the encoding processing block encodes a portion of the segment before the entire segment has been captured; and
a transmitting processing block that transmits the encoded segment from the first computer system for reception by a second computer system.

23. A method of displaying a video stream, the method comprising:
receiving an encoded segment of video at a computer system;
decoding the encoded segment at the computer system, wherein decoding the encoded segment comprises decoding a portion of the encoded segment before the entire encoded segment has been received; and
displaying the decoded segment on a display device in communication with the computer system.

24. A method of displaying a video stream, the method comprising:
receiving an encoded segment of video at a computer system;
decoding the encoded segment at the computer system; and
displaying the decoded segment on a display device in communication with the computer system, wherein displaying the encoded segment comprises displaying a portion of the segment before the entire segment has been decoded.

25. An apparatus, comprising:
a computer readable medium having encoded thereon a set of instructions executable by one or more computers to perform one or more operations, the set of instructions comprising:
instructions for receiving an encoded segment of video at a computer system;
instructions for decoding the encoded segment at the computer system, wherein the instructions for decoding the encoded segment comprise instructions for decoding a portion of the encoded segment before the entire encoded segment has been received; and
instructions for displaying the decoded segment on a display device in communication with the computer system.

26. A computer system, comprising:
one or more processors; and
a computer readable medium in communication with the one or more processors, the computer readable medium having encoded thereon a set of instructions executable by the computer system to perform one or more operations, the set on instructions comprising:
instructions for receiving an encoded segment of video;
instructions for decoding the encoded segment at the computer system, wherein the instructions for decoding the encoded segment comprise instructions for decoding a portion of the encoded segment before the entire encoded segment has been received; and
instructions for displaying the decoded segment on a display device in communication with the computer system.

27. A system, comprising:
one or more processors; and
a receiving processing block that receives an encoded segment of video at a computer system;
a decoding processing block that decodes the encoded segment at the computer system, wherein the decoding processing block decodes a portion of the encoded segment before the entire encoded segment has been received; and
a displaying processing block that displays the decoded segment on a display device in communication with the computer system.
